(19) United States
(12) Patent Application Publication
(10) Pub. No.: US 2004/0123004 A1
(43) Pub. Date: Jun. 24, 2004

(54) AN IMPROVED FIFO BASED CONTROLLER CIRCUIT FOR SLAVE DEVICES ATTACHED TO A CPU BUS

(75) Inventors: Gerard Boudon, Mennecy (FR); Didier Malcavet, Champcueil (FR)

Correspondence Address: INTERNATIONAL BUSINESS MACHINES CORPORATION, DEPT. 18G, BLDG. 300-482, 2070 ROUTE 52, HOPEWELL JUNCTION, NY, 12533, US

(73) Assignee: INTERNATIONAL BUSINESS MACHINES CORPORATION, Armonk, NY (US)

(21) Appl. No.: 10/605,944

(22) Filed: Nov. 7, 2003

(30) Foreign Application Priority Data
Dec. 19, 2002 (FR) 02368139.8

(51) Int. Cl. G06F 15/00; G06F 7/38; G06F 13/00

(52) U.S. Cl. 710/100; 712/220

(57) ABSTRACT

There is described an improved FIFO based controller (12) for controlling the transfer of data from a CPU, typically a microprocessor, to a slave device (e.g. a SRAM) attached thereto to perform the management of tasks (or transactions). To improve performance, parallel access to the FIFO has been implemented in order to process pipe lined tasks in a shortened time. A task consists of an address (Address) and its associated qualifying bits (ST). The improved controller circuit (12) is comprised of four blocks: a task detection circuit (16), a FIFO controller (12), an innovative task management circuit (18) including the FIFO memory (19) and finally, a slave controller (20). The role of the task detection circuit is to detect valid tasks and inhibiting others. The FIFO controller generates signals to add new tasks in the FIFO memory (ADD TASK) and to clear tasks that have been executed when the data are available on the processor bus (CLEAR TASK). When a valid task is presented in parallel to all the fields of the FIFO memory, it is stored in the first free field thereof. A valid bit (V) stored in a register (27-x) associated to this field is set to prevent writing a new task therein. In particular, the above circuit is very useful to control a dual port SRAM attached as a slave device to the processor bus of a 750 PowerPC microprocessor.

### BACKGROUND OF INVENTION

The present invention relates to digital signal processing circuits for controlling the transfer of data from a CPU (Central Processing Unit), typically a microprocessor, to a slave device to perform the management of tasks (or transactions). It more particularly relates to an improved FIFO based controller circuit wherein the FIFO (First In First Out) memory is provided with a mechanism which allows to present a group of pipe lined tasks in parallel to all fields thereof and to automatically store the first task of said group in the first free field and so on until the FIFO memory is fully filled.

FIG. 1 shows the block diagram of a conventional system architecture referenced 10 which combines a CPU 11, a controller circuit 12 and a slave device 13 which is attached to the processor bus 14 of the CPU 11, for data transfer under the management of controller circuit 12. The controller circuit 12 is also connected to the processor bus 14 to receive tasks from the CPU 11 and it operates under its control. In turn, it sends tasks and control signals to the slave device 13 and control signals to the bridge 15 via processor bus 14. Bridge 15 interfaces the CPU 11 with both a PCI bus and the system memory.

When the CPU is a PowerPC (a registered trade mark of IBM Corp.) microprocessor, such as the 750 PowerPC, controller circuit 12 has the key role to resynchronize every data with its corresponding task. The PowerPC microprocessor has the peculiarity of serially transmitting the tasks wherein some have no corresponding data. For instance, a determined slave device can receive tasks that must be exploited by other slave devices. In addition, when a slave device (SRAM memory, printer, . . . ) is attached to the processor bus of a PowerPC microprocessor, it is very frequent that the tasks are emitted before the corresponding data are made available in the slave device. Control signals sent by controller circuit 12 the slave device 13 depends on the nature thereof. In the case where a SRAM memory is used as the slave device 13, these control signals include the Read/Write Data, Chip Select signals, and the like as standard. Among control signals generated by controller circuit 12 to the bridge 15, a specific control signal usually labeled L2HIT has the key role of implementing a L2 level cache.

When the 750 PowerPC microprocessor is used, the main problem is thus to timely associate the flow of data with their corresponding task in the slave device. Conventional controller circuits performing the task management of a slave device are generally based on a FIFO memory. The FIFO memory stores all the tasks occurring on the PowerPC bus. By task it is meant an address and the qualifying bits associated thereto according to rules strictly defined by the PowerPC bus protocol. This is a totally serial process because the tasks are loaded in the FIFO memory one after another. In a standard FIFO memory, the tasks are generally loaded when it is empty and output when it is filled. Such a controller circuit is thus not well adapted when fast processing is required, in particular, when several tasks are pipe lined on the PowerPC bus.

### SUMMARY OF INVENTION

It is therefore a primary object of the present invention to provide an improved FIFO based controller circuit for controlling the transfer of data from a CPU to slave devices attached to the CPU bus wherein a parallel access is implemented in the FIFO memory for shortened data transfer time.

It is another object of the present invention to provide an improved FIFO based controller circuit for controlling the transfer of data from a CPU to slave devices attached to the CPU bus wherein pipe lined tasks can be processed in parallel for higher performance.

According to the present invention there is described an improved FIFO based controller circuit for controlling the transfer of data from a CPU to slave devices attached to the CPU bus wherein the FIFO (First In First Out) memory is provided with a mechanism which allows to present a group of pipe lined tasks (a task consists of an address and its associated qualifying bits) in parallel to all the fields of the FIFO memory and to automatically store the first task of said group in the first free field thereof and so on until all the tasks are stored. Said improved FIFO based controller comprising:

a task detection circuit coupled to the processor bus that detects valid tasks, i.e. tasks having an address that will be followed by corresponding data and inhibiting others (e.g. “address only” tasks);

a FIFO controller coupled to said task detection circuit that generates an ADD TASK signal to add new tasks to be performed in said FIFO memory, a CLEAR TASK signal that clears all tasks there from that have been executed when said data are available on the processor bus, and a control signal that is applied to gating means for only enabling said valid tasks to be presented on a dedicated bus; and,

a task management circuit coupled to said FIFO controller comprising:

a FIFO memory connected to said dedicated bus, provided with a plurality of storage fields forming a pile, each field being identified by a determined address and configured to store any valid task presented on said dedicated bus in parallel to all of said storage fields; and,

logic means that inhibit the writing of a task in the field (s) of the FIFO memory where a valid task has been entered and enable said writing in the first free field or in all the free fields below in the pile

The improved FIFO based controller circuit of the present invention is well adapted to process pipe lined tasks on the bus (60X) of the 750 PowerPC microprocessor.

The novel features believed to be characteristic of this invention are set forth in the appended claims. The invention itself, however, as well as other objects and advantages thereof, may be best understood by reference to the following detailed description of an illustrated preferred embodiment to be read in conjunction with the accompanying drawings.

### BRIEF DESCRIPTION OF DRAWINGS

FIG. 1 shows the block diagram of a conventional system architecture wherein a slave device is attached to the processor bus of a CPU for data transfer therebetween under the management of a controller circuit.

FIG. 2 schematically shows the construction of the improved FIFO based controller circuit wherein a parallel access has been implemented in the FIFO memory of the task management circuit according to the present invention.

FIGS. 3a-3d schematically show the operation of the task management circuit through different processing steps.

FIG. 4 shows the truth table of the task management circuit operation in the more general case as a function of the initial state, the ADD TASK and CLEAR TASK signals.

FIG. 5 shows a preferred detailed implementation of the logic block 21 depicted in FIG. 2 to adequately perform the writing operation in the FIFO memory in the first free field thereof according to the present invention.

FIG. 6 shows another preferred detailed implementation of the logic block 21 wherein writing a valid task in the FIFO memory is performed in all the free fields and not only in the first free field.

### DETAILED DESCRIPTION

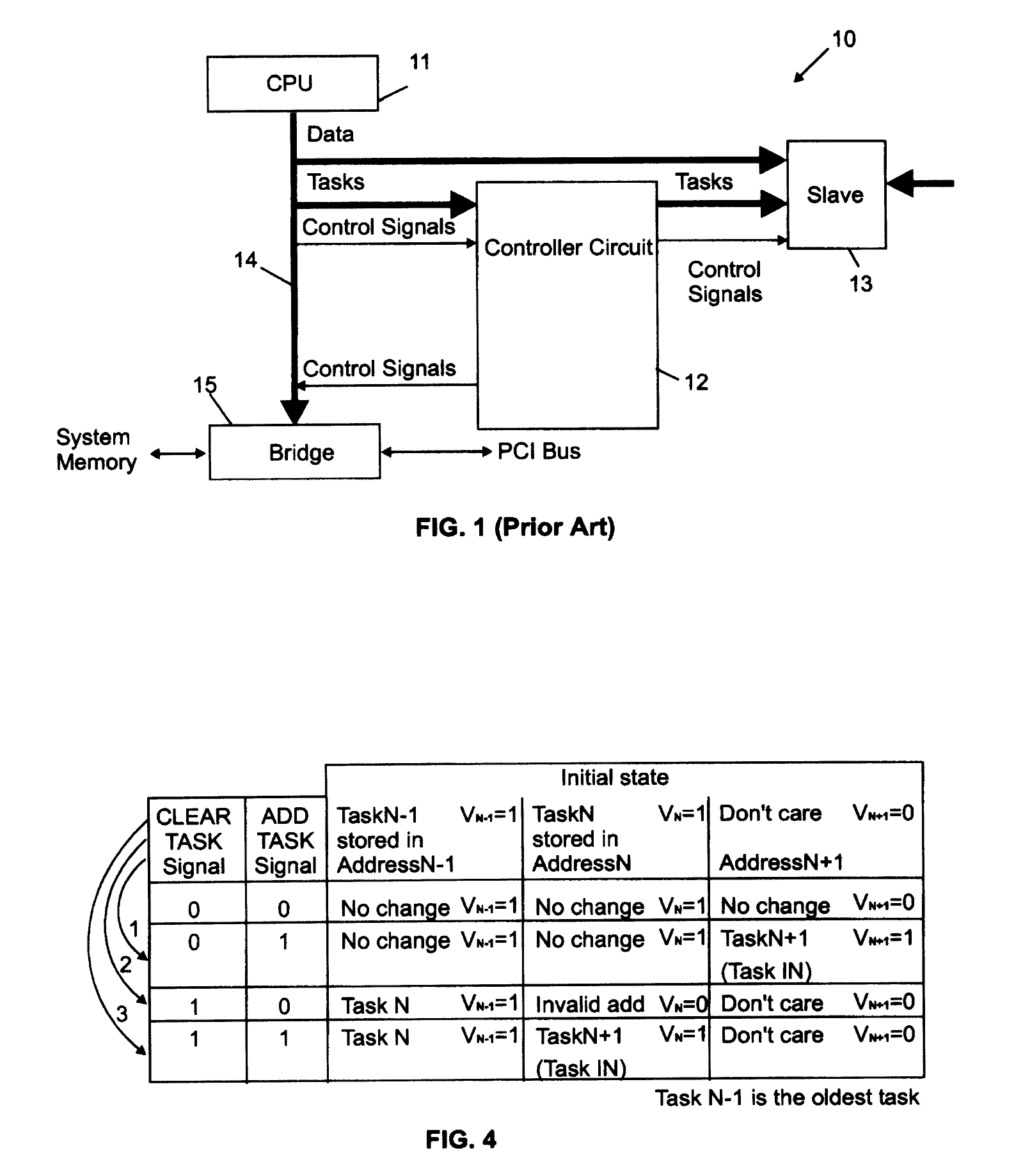

For the sake of illustration, the present invention will be described by reference to the system architecture shown in FIG. 1, in the particular case where the slave device consists of a dual port SRAM memory and the CPU is a 750 PowerPC microprocessor. The dual port SRAM memory is attached to the PowerPC bus usually referred to as the 60X bus. This bus, as known for those skilled in the art, is double, one bus transports the addresses (i.e. in reality the tasks) and the other the data, so that two phases have to be considered, first an “address phase”, then a “data phase”.

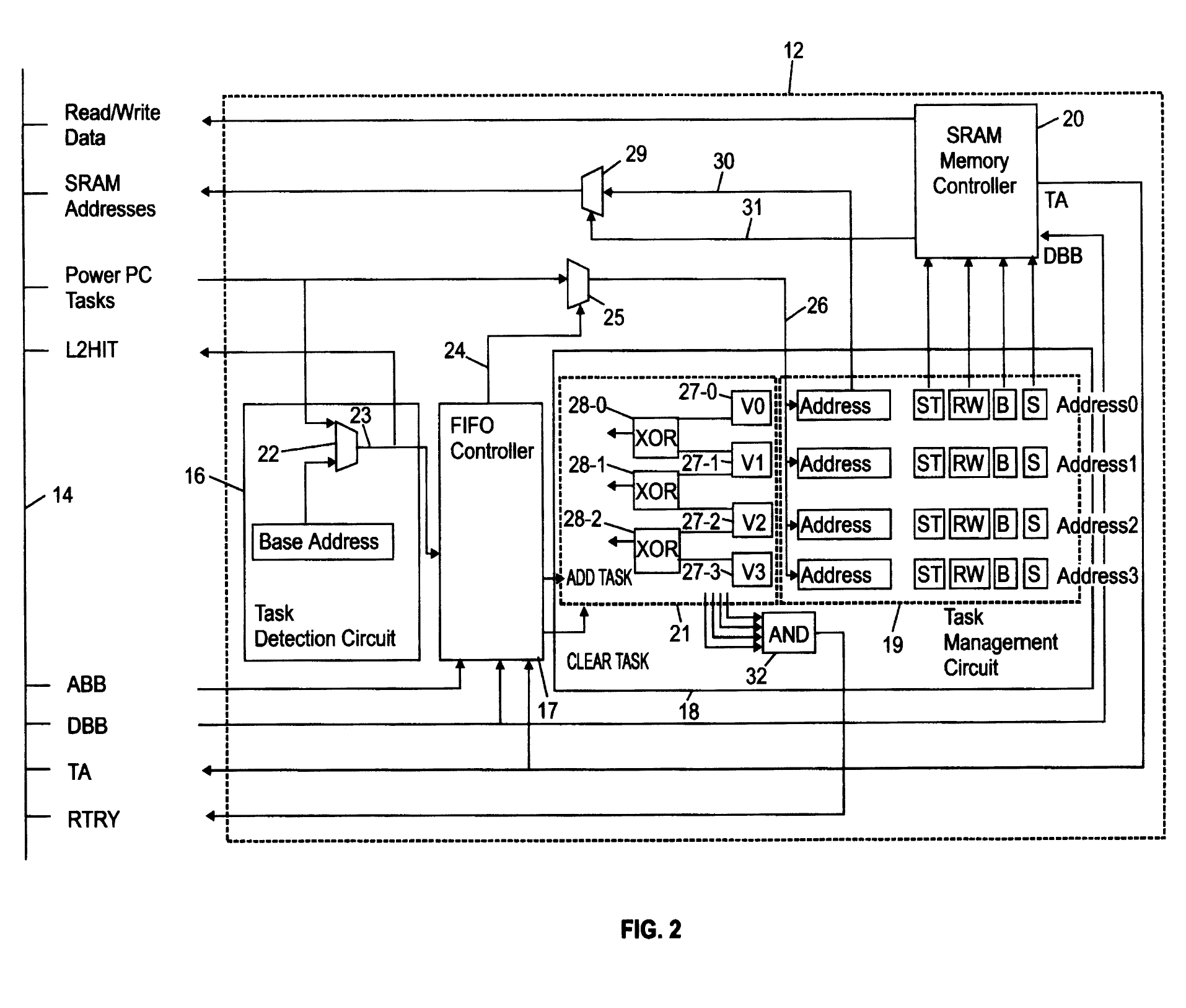

FIG. 2 schematically shows the construction of the improved FIFO based controller circuit 12 of the present invention wherein a parallel access has been implemented in the FIFO memory. Now turning to FIG. 2, improved FIFO based controller circuit 12 is basically comprised of four blocks: a detection circuit 16, a FIFO controller 17, an innovative task management circuit 18 which is organized around the FIFO memory 19 and finally, a SRAM memory controller 20.

Detection circuit 16, FIFO controller 17 and SRAM memory controller 20 are standard circuits. In essence, innovative task management circuit 18 includes the FIFO memory 19 and a logic block 21. Let us assume that the FIFO memory 19 is designed to store up to four tasks. As mentioned above, by “task” it is meant the combination of an address and a plurality of qualifying bits associated thereto according to the PowerPC (60X) bus protocol. Tasks are thus stored at four different fields, the addresses of which are labeled Address0 to Address3. As apparent in FIG. 2 there are four qualifying bits labeled ST, RW, B and S, per task to store. The role of these qualifying bits will be explained later on in due course.

Detection circuit 16 is used for detecting tasks that are within the address range of the SRAM memory and inhibiting others. It is in charge of decoding the base address and the address range of the SRAM memory (assuming the addressable memory space is partitioned as standard). Base address is compared with the address presented by the PowerPC in comparator 22. When these addresses match, the above mentioned L2HIT signal is immediately sent to the bridge 15 via bus 23 and PowerPC bus 14 to prevent bridge 15 to answer to any request. Moreover, L2HIT signal is also applied to the FIFO controller 17.

The FIFO controller 17 is organized around a processor. It generates signals that control all moves in the FIFO memory 19. In particular, it is in charge of adding new tasks to be performed and to clear all tasks that have been executed when the data are available on the PowerPC bus 14. It also generates a gating signal on bus 24 for storing “valid” tasks only, i.e. tasks followed by a corresponding data a task, excluding thereby “address only” tasks. To that end, this gating signal is applied to selector 25 to allow or not the loading of a task in the FIFO memory 19 via bus 26. As apparent in FIG. 2, a valid task presented on bus 26 is applied in parallel to the four FIFO memory 19 fields referred to by their respective addresses: Address0 to Address3. As a result, “address only” tasks are not stored and will not be subsequently exploited. However, although an “address only” task is not followed by a corresponding data, it has however some utility for resynchronization purposes according to the PowerPC (60X) bus protocol. On the contrary, a valid task is stored in the FIFO memory 19 and the address it contains, will be used later on when the corresponding data is valid on the PowerPC bus. Schematically, a valid task is stored in the first free field of FIFO memory 19. For instance, after a reset operation, assuming a sequence of incoming valid tasks, they will be stored in the FIFO memory 19 in their order of arrival Task0 at Address0, Task1 at Address1 and so on. However, Task0 could be filled in all the free fields as well, because it will be overwritten at Address1 when Task1 is stored, and so on.

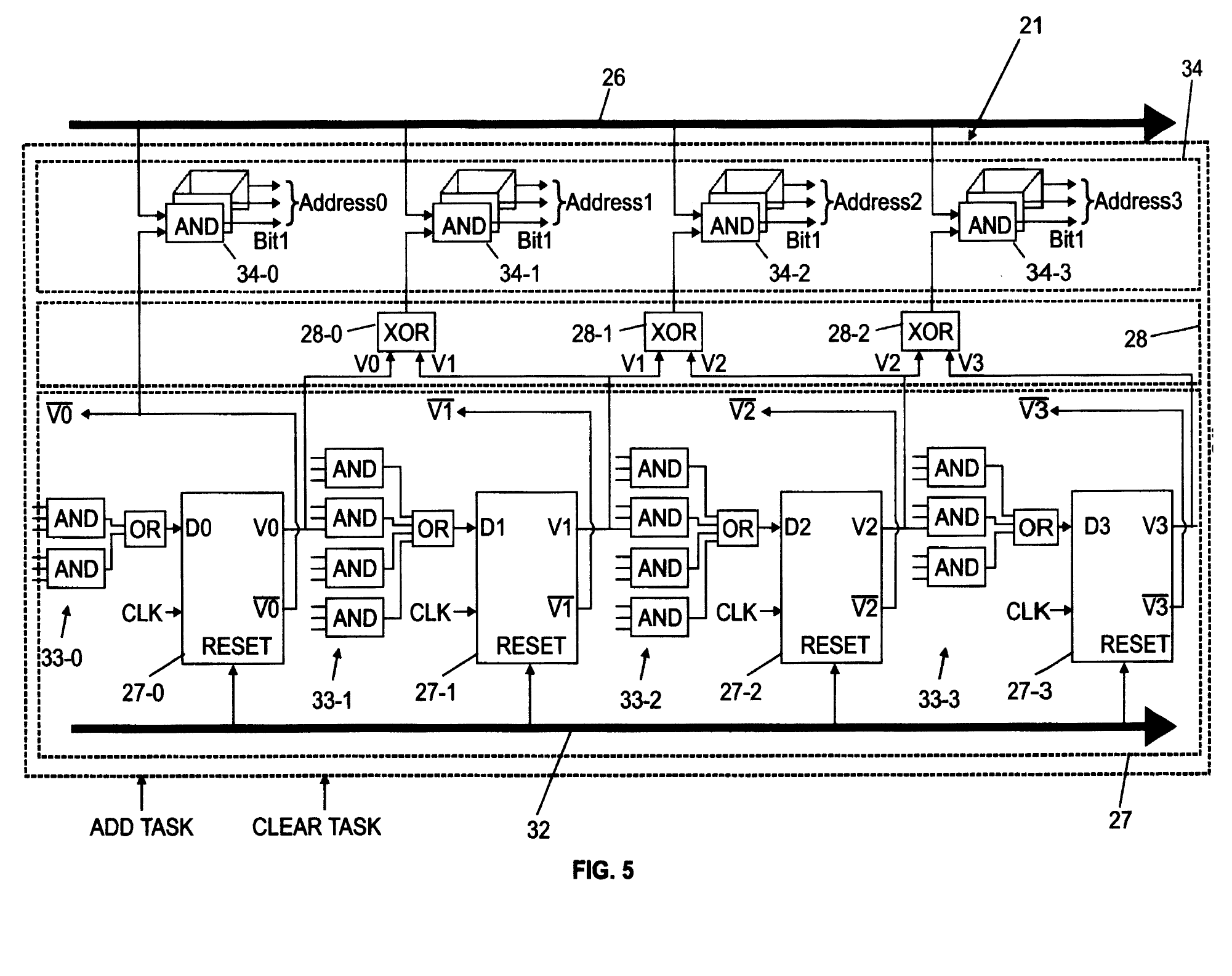

FIG. 2 only shows the essential elements composing logic block 21 of the task management circuit 18 for the sake of illustration. Logic block 21 comprises four 1-bit registers 27-0 to 27-3, one per address and three XOR gates 28-0 to 28-2. Each of the 1-bit register 27-0 to 27-3 stores a flag bit referred to as the “Valid Task” bit or valid bit V in short, labeled V0, V1, V2 and V3 respectively. If a valid task (address plus qualifying bits) is loaded in the FIFO memory 19 at a determined Address, the valid bit V associated thereto is set to one to indicate that a valid task has been stored therein to prevent any further overwriting. An incoming task is presented in parallel on the four memory fields, but it will be loaded at the first field for which the valid bit V is set to zero. This is obtained by the special design of logic block 21 (a detailed implementation thereof is shown in FIG. 5). The outputs of two consecutive 1-bit registers are XORed in the XOR gate associated thereto. For instance, as apparent in FIG. 2, XOR gate 28-2 operates a XOR function between the contents of 1-bit registers 27-3 and 27-2. This particular combination of the XOR gates and the 1-bit registers that store the valid bit V associated to each address is thus to identify the first free field (or all the free fields) in the FIFO memory 19. It is the role of the valid bit V to validate the address associated therewith and permit to add new tasks in the FIFO memory 19 and to clear tasks that have been exploited as well. The FIFO memory 19 is configured to store the above mentioned qualifying bits that qualify the associated address, i.e. the processing to be subsequently performed at the availability of the corresponding data on the PowerPC bus. These qualifying bits include the ST bit (valid for Slave Transfer), the RW bit (Read/Write), the B bit (Burst) when incoming data are consecutive and the S bit (Size) to define the bus size depending upon it conveys bytes, words, . . . etc. As apparent in FIG. 2, the FIFO memory 19 (which stores the valid tasks) is connected to selector 29 via bus 30 to output the active task stored at Address0. In addition, the memory positions storing the qualifying bits are also connected to the SRAM memory controller 20. As it will be explained in more details later on, when signal DBB is active, the task stored at field Address0 is output from FIFO memory 19 and transmitted via selector 29 to the PowerPC bus 14. This operation is enabled by the SRAM memory controller 20 via bus 31. As a result, all the qualifying bits (or some of them) included in this task are sent to SRAM memory controller 20, and then are made available on the PowerPC bus 14.

Task management circuit 18 further includes a four-way AND gate 32. The inputs of AND gate 32 are the outputs of 1-bit registers 27-0 to 27-3. Signal RTRY output by AND gate 32 is equal to one when the FIFO memory 19 is full, i.e. all the valid bits V0-V3 are equal to one. This signal is emitted and sent to the PowerPC via the PowerPC bus 14 to initiate another attempt later on.

In essence, the SRAM memory controller 20 generates signals that allow the transmission of tasks to the PowerPC bus 14 during the data phase of the PowerPC, only when the ST bit is active. Tasks are then processed according to conditions specified by the RW, B and S qualifying bits stored in the FIFO memory 19. As mentioned above, with the PowerPC bus 14, data occur later than the address phase, so that addresses and control signals are sent to the SRAM memory for Read/Write the data only when said data become available on the PowerPC bus 14. It is the role of the ABB (Address Bus Busy), DBB (Data Bus Busy) and TA signals to initiate appropriate actions in the FIFO controller 17 and the SRAM memory controller 20, to generate adequate control signals if the task to be stored is qualified for a SRAM memory access.

In summary, at this stage of the description, it must be clear that the role of the FIFO memory 19 consists to store four valid tasks, wherein each valid task consists of an address and the four qualifying bits associated thereto, for the SRAM memory operation. According to the present invention, two important signals, the ADD TASK and CLEAR TASK signals are implemented to add a new task in the FIFO memory 19 and to move a task therefrom respectively. The ADD TASK and CLEAR TASK signals are active when respective ABB and DBB signals are active. The qualifying bits stored in the FIFO memory 19, i.e. ST, RW, B and S are used during the transfer of the data to the SRAM memory.

On the other hand, the four valid bits V associated to the four tasks are determining for task management. Because any valid task (e.g. qualified for the SRAM memory) presented on the PowerPC bus 14, is stored in the FIFO memory 19 in the first free field (and the following as well), it is necessary that the valid V bit associated to this field be set to 1. This valid task will be subsequently used when the corresponding data become valid on the PowerPC bus. As apparent in FIG. 2, the FIFO memory 19 can store up to 4 pipe lined addresses but it can be extended to more if required by the number of pipe lined PowerPC buses. Therefore, the valid bit V associated with a task is set to one when this task is added to the FIFO memory 19. A new task is added in the FIFO memory 19 at the place just below the last task that has a valid bit V set to 1. When a task at the top of FIFO memory 19 is cleared, all the tasks below in the pile are shifted up, so that new Task0 is the previous Task1 and so on.

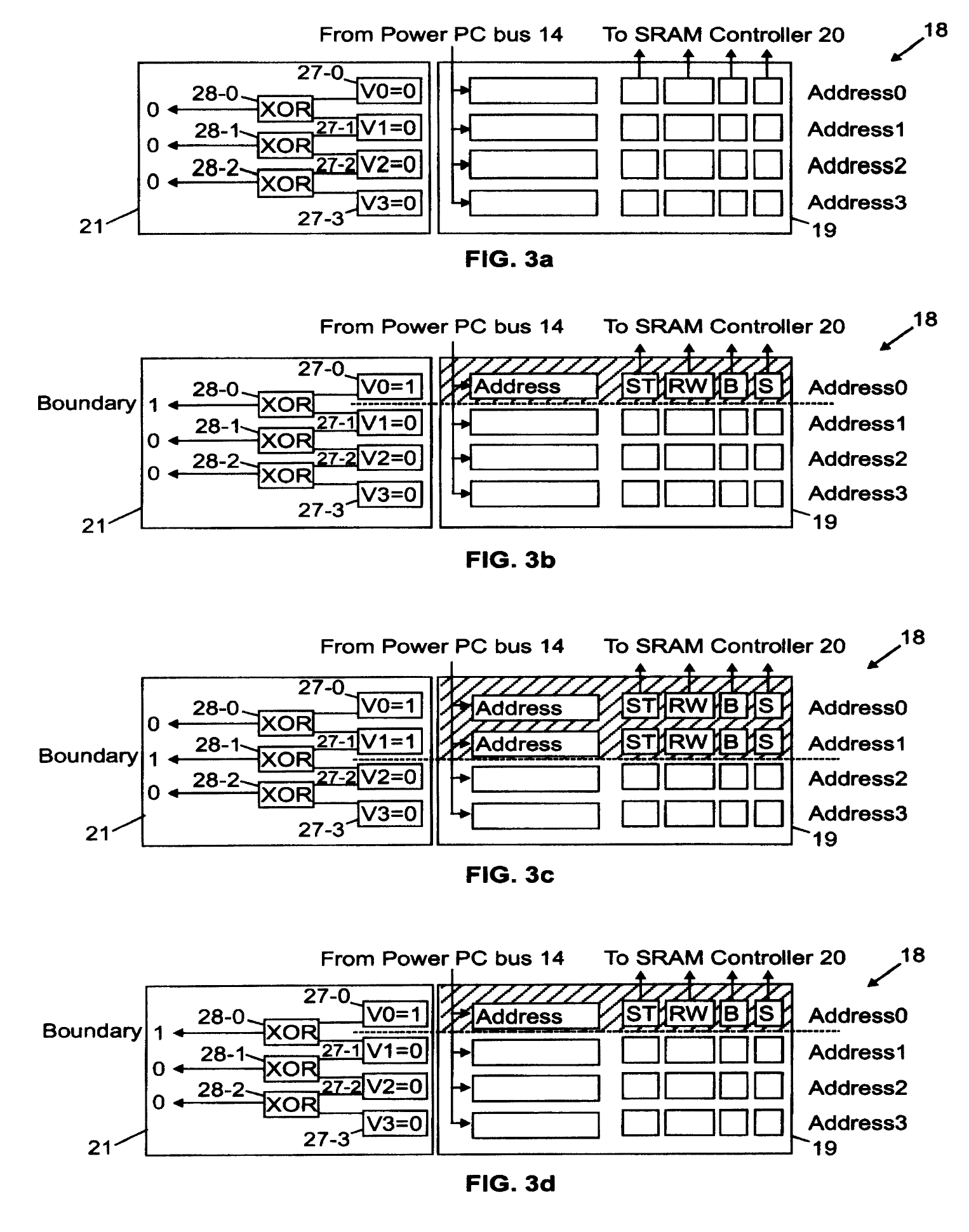

The operation of the task management circuit 18 will be better understood by the following description made by reference to FIGS. 3a-3d. As mentioned above, valid bit V is essential to the task management circuit 18. When set to 1, it indicates that a valid task presented on the PowerPC bus (“Address only” tasks are excluded) has been stored in the corresponding field of the FIFO memory 19, and this field is now frozen. As a result, the FIFO memory 19 is permanently divided in two zones that are variable in size. The boundary is defined between a so-called “valid zone” where the valid tasks are stored (valid bits V are equal to 1) that must not be impacted by any writing operation and an invalid or empty zone where (valid bits V are equal to 0) in which writing a valid task is permitted. The tasks stored in the valid zone are those for which the address phase has been completed on the PowerPC bus and are waiting to be exploited during the data phase. These two phases are validated by the ABB and DBB signals on the PowerPC bus 14 respectively. Tasks are also stored in the empty zone, but they will not be exploited and will be overwritten. As a result, the oldest task is always at the top of the FIFO memory 19 pile.

Let us consider FIG. 3a, the task management circuit 18 is shown after a reset step. All valid bits V0 to V3, in registers 27-0 to 27-3 and the outputs of XOR gates 28-0 to 28-2 are set to zero. The content at the four memory fields specified by addresses Address0 to Address3 in the FIFO memory 19 is irrelevant.

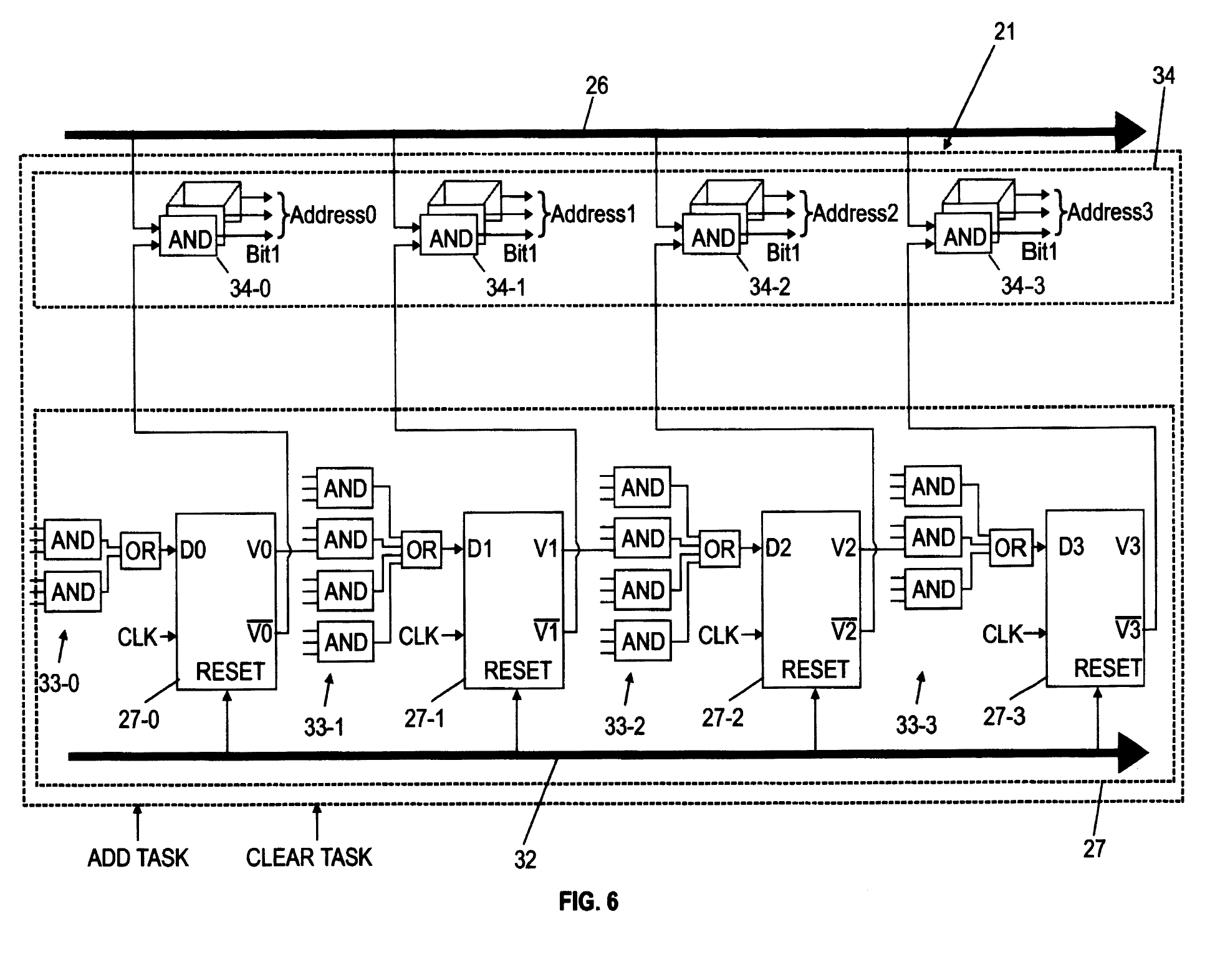

Now turning to FIG. 3b, let us assume that a valid task, e.g. Task0, is presented to the task management circuit 18 with the ADD TASK signal active, it is stored either in the first free field (or in all fields as well), but only the valid bit V0 associated to Address0 is set to 1. The output of XOR gate 28-0 then raises to one while the output of other XOR gates still remain to zero. As a result, there is defined a valid task area (hatched zone) and an invalid task area with a boundary therebetween (see dotted line). According to the present invention, it is not possible to write in the FIFO memory 19 above the boundary by construction, but only just below it. Preferred implementations of a logic circuit 21 configured to perform this special writing operation will be described hereafter by reference to FIGS. 5 and 6. At this stage of the process, Task0 is stored is stored in the first field at address0 (if the FIG. 5 circuit is used) or in the four fields of the FIFO memory 19, i.e. at addresses Address0 to Address3, (if the FIG. 6 circuit is used instead).

Assuming we want to add a new task, e.g. Task1. This task is presented to the task management circuit 18 with the ADD TASK signal again active, it cannot be stored at Address0 because the valid bit V0 is equal to one, preventing any access above the boundary as explained above, it will thus be stored at Address1 only (or to Address1 to Address3) overwriting the previously stored address Task0 therein. At this stage illustrated by FIG. 3c, two valid tasks appearing on the PowerPC bus have been stored, Task0 is stored at Address0 and Task1 is stored at Address1. Valid bit V1 is set to one, so that the output of XOR gate 28-1 is now at one, while the output of XOR gate 28-0 switches to zero, a new boundary is thus defined, extending the valid area of FIG. 3b.

Let us assume now that the CLEAR TASK signal becomes active. The first task stored at Address0 in the FIFO memory 19, i.e. Task0, is emitted on the bus 30, and all the stored tasks are shifted upwards, so that the Task1 stored as Address1 passes in Address0. Valid bit V1 is set at zero, and thus the output of XOR gate 28-1 passes to zero, while the output of XOR gate 28-0 raises to one. As a result, the boundary is also shifted up as illustrated in FIG. 3d.

The truth TABLE depicted in FIG. 4 represents the global operation of the innovative task management circuit 18 of the present invention, and in particular it depicts how tasks are managed, as a function of the initial state depicted in FIG. 4, the ADD TASK and CLEAR TASK signals. The initial state corresponds to the situation shown in FIG. 3c, where Task0 is stored at address0, Task1 stored at Address1, no valid task being stored at Address2. In the general case shown in FIG. 4, TaskN−1 and TaskN are stored at AddressN−1 and AddressN respectively. Nothing relevant is stored at AddressN+1. When the ADD TASK signal is active (arrow 1), the new task, i.e. TaskN+1 is entered at AddressN+1 (Task IN) and the valid bit attached thereto V_{N+1} raises from 0 to 1. A similar reasoning applies when the CLEAR TASK signal becomes active (arrow 2). The most critical event is when both ADD TASK and CLEAR TASK signals are active at the same time (arrow 3). In this case, all operations have to be completed in one system clock cycle. First, the CLEAR TASK operation is performed with shifting up of the stored tasks, and then the CLEAR TASK is performed, so that the new task is stored after the boundary, in the non valid area, as explained above. Because these operations, i.e. ADD TASK and CLEAR TASK are totally asynchronous, an ADD TASK followed by a CLEAR TASK has the same effect as a CLEAR TASK followed by an ADD TASK.

FIG. 5 shows a preferred implementation of logic block 21 that allows to enter a task in the first free field of the invalid area and to automatically set the valid bit V attached to this address to one so that this field of the FIFO memory then becomes part of the valid area. The four FIFO memory 19 fields are controlled by the valid bits V0, V1, V2 and V3 which are the outputs of 1-bit registers 27-0 to 27-3 shown in FIG. 2. These registers are updated at each system clock cycle as standard according to logic equations given below. As a matter of fact, the output of a register at a given time depends on the ADD TASK, CLEAR TASK signals and of the previous value of the register (if ADD TASK signal is active) or the next value thereof (if CLEAR TASK signal is active). After a reset operation, all these registers are set to zero: no task to execute, as far as there is no CLEAR TASK or ADD TASK signal, the registers keep this value.

Now referring to FIG. 5, logic block 21 is organized around four registers 27-0 to 27-3, forming block 27, that are conventional D-flipflops. Each D-flipflop has a single data input D, two data outputs V and NOT V, one clock input CLK and one reset input RESET as standard. All reset inputs are connected to a dedicated bus 32. As known for those skilled in the art, V=D one system clock cycle later. Each data input D0 to D3 of registers 27-0 to 27-3, is driven by a logic block referenced 33-0 to 33-3 respectively, each logic block being composed of a few AND gates and one OR gate performing the logic equations that follow. It is to be noted in these equations that ADD=ADD TASK and CLEAR=CLEAR TASK for the sake of simplicity.

Logic block 33-0 that is made of two AND gates and one OR gate drives data input D0 of D-flipflop 33-0 to perform:

V0=NOT V1 AND NOT ADD AND CLEAR OR NOT V0 AND NOT ADD AND NOT CLEAR

Logic block 33-1 that is made of four AND gates and one OR gate drives data input D1 of D-flipflop 33-1 to perform:

V1=NOT V1 AND ADD AND CLEAR OR NOT V2 AND NOT ADD AND CLEAR OR NOT V0 AND ADD AND NOT CLEAR OR NOT V1 AND NOT ADD AND NOT CLEAR

Logic block 33-2 that is made of four AND gates and one OR gate drives data input D2 of D-flipflop 33-2 to perform:

V2=NOT V2 AND ADD AND CLEAR OR NOT V3 AND NOT ADD AND CLEAR OR NOT V1 AND ADD AND NOT CLEAR OR NOT V2 AND NOT ADD AND NOT CLEAR

And finally, logic block 33-3 that is made of three AND gates and one OR gate drives data input D3 of D-flipflop 33-3 to perform:

V3=V3 AND ADD AND CLEAR OR V2 AND ADD AND NOT CLEAR OR V3 AND NOT ADD AND NOT CLEAR

These logic equations permit to appropriately and automatically move the boundary between the valid and the invalid zones, downwards after an ADD TASK and upwards after a CLEAR TASK operation.

On the other hand, valid bits V0 to V3 are exploited to feed the four XOR gates 28-0 to 28-3 (that are schematically illustrated in FIG. 2) forming logic block 28. For each bit of a task transported on bus 26 and for each field of the FIFO memory 19, a two-way AND gate is used to allow the writing operation or not. Still for that bit, because in the above description there are four memory fields (Address0 to Address3), there are thus four AND gates referenced 34-0 to 34-3 depicted in FIG. 5. AND gate 34-0 receives NOT V0 and the first bit of the valid task transported on bus 26 to be written at Address0. Assuming that a task comprises an address coded on 32 bits and there are still four qualifying bits, bus 26 thus conveys a total of 36 bits to be stored at each field of the FIFO memory 19. As a result, there is a battery of 36 AND gates such as 34-0. The same reasoning applies to other AND gates 34-1 to 34-3. AND gate 34-1 receives V0 XOR V1 and the first bit to be written at Address1. Likewise, AND gate 34-2 receives V1 XOR V2 and the first bit to be written at Address2. Finally, AND gate 34-3 receives V2 XOR V3 and the first bit to be written at Address3. The four batteries of AND gates 34-0 to 34-3 form logic block 34.

FIG. 6 shows an alternate solution of logic block 21 wherein, a valid task is written in all the free fields of the FIFO memory 19 and not only in the first free field. In this implementation, the block 28 is eliminated. The first input of AND gates 34-0 to 34-3 receive signals NOT V0 to NOT V3 (instead of the output of XOR gates 28-0 to 28-3) respectively.

While the invention has been particularly described with respect to a preferred embodiment thereof it should be understood by one skilled in the art that the foregoing and other changes in form and details may be made therein without departing from the spirit and scope of the invention.

1. An improved FIFO based controller (12) for slave devices attached to the processor bus (14) of a CPU (11) for processing tasks and storing them in a FIFO memory, wherein a task consists of an address (Address) and its associated qualifying bits (ST, . . . ), comprising:
first logic means (16,17) for enabling valid tasks, i.e. tasks having an address useful for at least one slave device, i.e. that will be followed by corresponding data and inhibiting others (e.g. “address only” tasks) to be presented on a dedicated bus (26); and,
a task management circuit (18) coupled to said first logic means comprising:
a FIFO memory (19) connected to said dedicated bus, provided with a plurality of N storage fields forming a pile, each field being identified by a determined address (Address0, . . . ) and configured to store any valid task presented on said dedicated bus in parallel to all of said storage fields; and,
second logic means (21) that inhibit the writing of a task in the field (s) of the FIFO memory where a valid task has been entered and enable said writing in the first free field below in the pile.

2. The improved FIFO based controller of claim 1 wherein said first logic means comprise:
a task detection circuit (16) coupled to the processor bus that detects valid tasks; and,
a FIFO controller (17) coupled to said task detection circuit that generates an ADD TASK signal to add new tasks to be performed in said FIFO memory, a CLEAR TASK signal that clears all tasks therefrom that have been executed when said corresponding data are available on the processor bus, and a control signal that is applied to gating means (25) for only enabling said valid tasks to be presented on said dedicated bus.

3. The improved FIFO based controller of claim 2 wherein a valid bit (V) stored in a register (27-x) is associated to each of said N fields, when it is set to a first binary value, this means that a valid task has been entered in the corresponding field.

4. The improved FIFO based controller of claim 3 wherein the output of each pair of consecutive registers (27-0,27-1) is connected to the inputs of a two-way XOR gate (28-0), so that only one output of the N−1 XOR gates is active (at “1”) indicating thereby the boundary between the field(s) of the FIFO memory where a valid task has been entered and the remaining free field(s).

5. The improved FIFO based controller of claim 1 said second logic means (21) enable said in all the free fields of the FIFO memory instead of only the first free field.

6. The improved FIFO based controller of claim 1 further comprising a slave controller (20) coupled to said processor bus and task management circuit.

7. The improved FIFO based controller of claim 1 wherein said CPU is a 750 PowerPC microprocessor.
